(19) United States
(12) Patent Application Publication
(10) Pub. No.: US 2014/0121986 A1
(43) Pub. Date: May 1, 2014

(54) SYSTEM AND METHOD FOR ALIGNING GENOME SEQUENCE

(71) Applicants: SAMSUNG SDS CO., LTD., Seoul (KR); INDUSTRY-ACADEMIC COOPERATION FOUNDATION, YONSEI UNIVERSITY, Seoul (KR)

(72) Inventors: Minseo PARK, Seoul (KR); Sang-Hyun PARK, Seoul (KR); Yun-Ku YEU, Seoul (KR)

(73) Assignees: SAMSUNG SDS CO., LTD., Seoul (KR); INDUSTRY-ACADEMIC COOPERATION FOUNDATION, YONSEI UNIVERSITY, Seoul (KR)

(21) Appl. No.: 13/972,035

(22) Filed: Aug. 21, 2013

(30) Foreign Application Priority Data
Oct. 29, 2012 (KR) 10-2012-0120650

(51) Int. Cl. G06F 19/22

(52) U.S. Cl. CPC G06F 19/22
USPC 702/19

(57) ABSTRACT

A system and a method for aligning a first and second genome sequences in a reference sequence includes a seed generation unit configured to generate one or more fragments from each of the first sequence and the second sequence and constitute a first seed group and a second seed group from the one or more fragments, a mapping value calculation unit configured to divide the reference sequence into a plurality of sections, and calculate a first mapping value of seeds included in the first seed group and a second mapping value of seeds included in the second seed group for each section, and an alignment unit configured to select a first section in which both the first and second mapping values are greater than or equal to a reference value and search for mapping positions of the first sequence and the second sequence in the first section.

### CROSS-REFERENCE TO RELATED APPLICATION

This application claims priority to and the benefit of Republic of Korea Patent Application No. 10-2012-0120650, filed on Oct. 29, 2012, the disclosure of which is incorporated herein by reference in its entirety.

### BACKGROUND

1. Field

The present disclosure relates to technology for analyzing a genome sequence.

2. Discussion of Related Art

A sequencing machine is used to produce reads, which are short genome sequences, from an original sequence. In this case, the reads are produced in pairs. Such reads making a pair are produced in a certain distance from an original DNA, so that the reads can be produced in a reversely complementary direction or the same direction with respect to a reference sequence, depending on the kind of a sequencing machine. In this case, a distance (i.e., an insert size) between the two produced reads and a length of each read are set in advance according to a purpose of genome sequence analysis, and all the reads produced in the same experiment have similar values. One read produced first in the reads making such a pair is referred to as a 5′ read, and the other read produced later in the reads is referred to as a 3′ read. When directions of the 5′ read and the 3′ read are in a reversely complementary relationship with each other, the reads are called paired-end reads, and when the 5′ read and the 3′ read are in the same direction, they are called mate-pair reads.

When such paired-end reads or mate-pair reads are aligned, the three conditions should be considered, as follows.

1) Genome sequence homology between each read and a reference sequence

2) Direction in which two reads are aligned

3) Distance between alignment positions of two reads

Conventional alignment algorithms are designed to align each of two reads in a reference sequence based on the condition 1), and select one of alignment positions of the two reads which satisfies the conditions 2) and 3). However, the conventional algorithms require an unnecessarily large amount of calculations are needed to obtain alignment positions of respective reads satisfying the condition 1), because the algorithms are designed to search even for positions of reads in the reference sequence which do not satisfy the conditions 2) and 3).

### SUMMARY

The present disclosure is for providing methods and apparatus for aligning a pair of reads capable of ensuring mapping accuracy and simultaneously improving complexity upon mapping to increase a processing rate.

According to an aspect of the present disclosure, there is provided a system of aligning a pair of genome sequences including a first sequence and a second sequence in a reference sequence, which includes a seed generation unit configured to generate one or more fragments from each of the first sequence and the second sequence and constitute a first seed group and a second seed group from the one or more fragments, a mapping value calculation unit configured to divide the reference sequence into a plurality of sections, and calculate a first mapping value of seeds included in the first seed group and a second mapping value of seeds included in the second seed group for each section, and an alignment unit configured to select a first section in which both the first and second mapping values are greater than or equal to a reference value and search for mapping positions of the first sequence and the second sequence in the first section.

The first seed group may include the fragments mapped to the reference sequence among the one or more fragments extracted from the first sequence, and the second seed group may include the fragments mapped to the reference sequence among the one or more fragments extracted from the second sequence.

The fragments mapped to the reference sequence may be fragments in which the number of unmatched bases is less than or equal to a predetermined number as seen from the results of exact matching with the reference sequence.

The first mapping value may be a total mapping length of the seeds included in the first seed group in each section, and the second mapping value may be a total mapping length of the seeds included in the second seed group in each section.

The first mapping value may be a total number of mapped seeds included in the first seed group in each section, and the second mapping value may be a total number of mapped seeds included in the second seed group in each section.

The alignment unit may be configured to calculate one or more alignment positions of the first sequence and the second sequence by performing global alignment in the first section, and select an alignment position pair among the one or more alignment positions, wherein the alignment position pair satisfies a predetermined distance range between the alignment positions of the first and second sequences.

The alignment unit may be configured to search for mapping positions of the first sequence and the second sequence in a second section when there are no sections in which both the first mapping value and the second mapping value are greater than or equal to the reference value, wherein the second section is a section in which either the first mapping value or the second mapping value is greater than or equal to the reference value.

The alignment unit may be configured to calculate an alignment position of the sequence selected from one of the first sequence and the second sequence in the second section and perform global alignment on the other sequence within a mappable range from the calculated alignment position.

The selected sequence may be one of the first sequence and the second sequence which has a relatively higher mapping value in the second section.

The mappable range may be a section corresponding to k*D (here, k represents a weight, and D represents a predetermined distance between the sequences) forward and backward of the reference sequence from the mapping position of the selected sequence.

The weight k may be less than or equal to 1.8.

According to another aspect of the present disclosure, there is provided a system of aligning a pair of genome sequences including a first sequence and a second sequence in a reference sequence, which includes an error estimation unit configured to calculate a minimum error bound of each of the first sequence and the second sequence, and an alignment unit configured to calculate an alignment position of either the first sequence or the second sequence which has a relatively lower value of the calculated minimum error bounds, with respect to the reference sequence and perform global alignment on the other sequence within a mappable range set based on the calculated alignment position, wherein the error estimation unit is configured to perform exact matching of the sequence selected from one of the first sequence and the second sequence with the reference sequence from a first base of the selected sequence one by one, provided that the error estimation unit is configured to newly perform the exact matching from a base next to a certain position of the selected sequence one by one when it is impossible to perform the exact matching at the certain position, and configured to set the number of positions at which it is judged not possible to perform the exact matching as a minimum error bound of the selected sequence when the error estimation unit reaches the last base of the selected sequence.

According to still another aspect of the present disclosure, there is provided a method of aligning a pair of genome sequences including a first sequence and a second sequence in a reference sequence at the system of aligning a pair of genome sequences, which includes generating, at a seed generation unit, one or more fragments from each of the first sequence and the second sequence and constituting a first seed group and a second seed group from the one or more fragments, dividing, at a mapping value calculation unit, the reference sequence into a plurality of sections and calculating a first mapping value of seeds included in the first seed group and a second mapping value of seeds included in the second seed group for each section, and selecting, at an alignment unit, a first section in which both the first and second mapping values are greater than or equal to a reference value and searching for mapping positions of the first sequence and the second sequence in the first section.

The first seed group may include the fragments mapped to the reference sequence among the one or more fragments extracted from the first sequence, and the second seed group may include the fragments mapped to the reference sequence among the one or more fragments extracted from the second sequence.

The fragments mapped to the reference sequence may be fragments in which the number of unmatched bases is less than or equal to a predetermined number as seen from the results of exact matching with the reference sequence.

The first mapping value may be a total mapping length of the seeds included in the first seed group in each section, and the second mapping value may be a total mapping length of the seeds included in the second seed group in each section.

The first mapping value may be a total number of mapped seeds included in the first seed group in each section, and the second mapping value may be a total number of mapped seeds included in the second seed group in each section.

The searching for the mapping positions may further include calculating one or more alignment positions of the first sequence and the second sequence by performing global alignment in the first section, and selecting an alignment position pair among the one or more alignment positions, wherein the alignment position pair satisfies a predetermined distance range between the alignment positions of the first and second sequences.

The searching for the mapping positions may further include searching for mapping positions of the first sequence and the second sequence in a second section when there are no sections in which both the first mapping value and the second mapping value are greater than or equal to the reference value, wherein the second section is a section in which either the first mapping value or the second mapping value is greater than or equal to the reference value.

The searching for the mapping positions may further include calculating an alignment position of the sequence selected from one of the first sequence and the second sequence in the second section, and performing global alignment on the other sequence within a mappable range set from the calculated alignment position, wherein the selected sequence is one of the first sequence and the second sequence which has a relatively higher mapping value in the second section.

According to yet another aspect of the present disclosure, there is provided a method of aligning a pair of genome sequences including a first sequence and a second sequence in a reference sequence at the system of aligning a pair of genome sequences, which includes calculating a minimum error bound of each of the first sequence and the second sequence at an error estimation unit, calculating an alignment position of one of the first sequence and the second sequence, which has a relatively lower value of the calculated minimum error bounds, with respect to the reference sequence at an alignment unit, and performing global alignment on the other sequence within a mappable range from the calculated alignment position at the alignment unit.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a diagram explaining a method 100 of aligning a pair of genome sequences according to one exemplary embodiment of the present disclosure;

FIG. 2 is a diagram exemplifying an mEB calculation process in Operation 104 of the method 100 of aligning a pair of genome sequences according to one exemplary embodiment of the present disclosure;

FIGS. 3A and 3B are detailed flowcharts illustrating Operation 114 of aligning a pair of genome sequences in the method 100 of aligning a pair of genome sequences according to one exemplary embodiment of the present disclosure;

FIG. 4 is a detailed flowchart illustrating an operation of searching for a valid pair in the method 100 of aligning a pair of genome sequences according to one exemplary embodiment of the present disclosure;

FIG. 5 is a block diagram showing a system 500 of aligning a pair of genome sequences according to one exemplary embodiment of the present disclosure; and

FIG. 6 is a block diagram showing a system 600 of aligning a pair of genome sequences according to another exemplary embodiment of the present disclosure.

### DETAILED DESCRIPTION OF EXEMPLARY EMBODIMENTS

Exemplary embodiments of the present disclosure will be described in detail below with reference to the accompanying drawings. While the aspects of present disclosure are shown and described in connection with exemplary embodiments thereof, it will be apparent to those skilled in the art that various modifications can be made without departing from the scope of the disclosure.

Also, descriptions of well-known functions and constructions may be omitted for increased clarity and conciseness. In addition, terms described below are terms defined in consideration of functions in the present disclosure and may be changed according to the intention of a user or an operator or conventional practice. Therefore, the definitions must be based on content throughout this disclosure. Prior to describing the exemplary embodiments of the present disclosure in detail, first, the terminology used herein will be described in advance, as follows.

First, the term “read sequence” (or abbreviated as “read”) refers to genome sequence data having a short length, which is output from a genome sequencer. A read generally is varied in length ranging from approximately 35 to 500 bp (base pairs) according to the kind of a genome sequencer. In general, DNA bases are represented by four characters: A, C, G, and T.

According to one exemplary embodiment of the present disclosure, the genome sequencer outputs a pair of reads making a pair. In this case, a first read among the pair of reads is referred to as a 5′ read, and a second read is referred to as a 3′ read. Here, direction of the 5′ read and the 3′ read are in a reversely complementary relationship in direction with each other (paired-end reads), or the 5′ read and the 3′ read are aligned in the same direction (mate-pair reads). In case of the paired-end reads, for example, when a 5′ read is a forward read, a 3′ read is a reversely complementary read, whereas, when the 5′ read is a reversely complementary read, the 3′ read is a forward read. Also, in case of mate-pair reads, when a 5′ read is a forward read, a 3′ read is also a forward read, whereas, when the 5′ read is a reversely complementary read, the 3′ read is also a reversely complementary read.

The “reference sequence” refers to a genome sequence used for reference to produce a full-length genome sequence from the reads. In analysis of the genome sequence, a large amount of reads output from a genome sequencer are mapped with reference to the reference sequence to complete the full-length genome sequence. According to the present disclosure, the reference sequence may be a sequence (for example, a full-length human genome sequence, etc.) set in advance upon analysis of a genome sequence, or a genome sequence synthesized in a genome sequencer may be used as the reference sequence.

The “base” refers to a basic unit constituting a reference sequence and a read. As described above, the DNA bases may be composed of four alphabets: A, C, G, and T, each of which is referred to as a base. That is, the DNA bases are represented by four bases. Likewise, this is also applicable to the read.

The term “fragment sequence” (or abbreviated as “fragment”) refers to a sequence which is a basic unit used when a read is compared with a reference sequence so as to map the read. In theory, mapping positions of reads should be calculated while sequentially comparing the entire read with the reference sequence beginning from the first base of the reference sequence so as to map the read to the reference sequence. However, such a method has a problem in that large amounts of a time and computing power are required to map one read. Therefore, a fragment that is a piece actually composed of a portion of the read is first mapped to the reference sequence to search for a mapping candidate position of the entire read and map the entire read at a corresponding candidate position (global alignment).

The “seed” refers to a fragment matching a reference sequence among fragments produced from a read. That is, according to one exemplary embodiment of the present disclosure, each of the fragments produced from the read is exactly matching the reference sequence, and subjected to a filtering process so as to exclude the fragments which are not exactly matching the reference sequence. The fragments exactly matching the reference sequence in the filtering process are referred to as seeds, and an assembly of seeds is referred to as a seed group. In this case, the fragments matching the reference sequence means fragments in which the number of unmatched bases upon exact matching with the reference sequence is less than or equal to a predetermined allowable value. In this case, when the allowable value is 0, the seed group includes only the fragments exactly matching the reference sequence (that is, there are no unmatched bases).

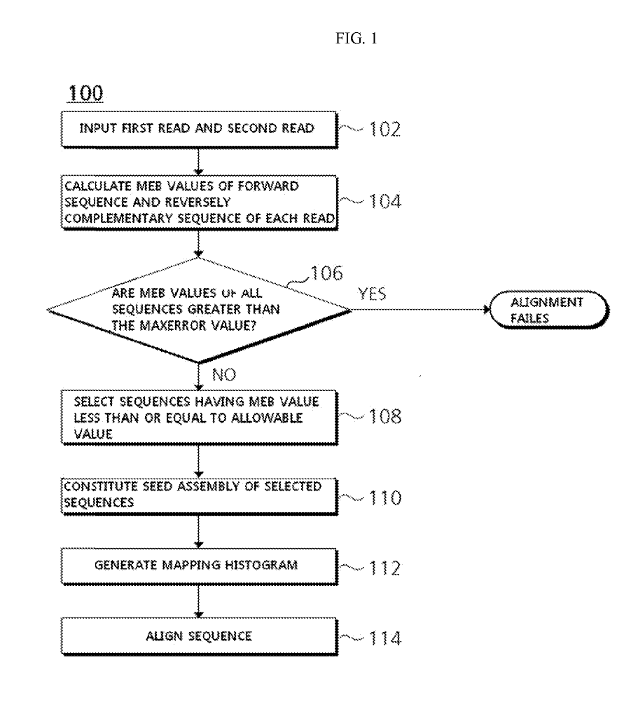

FIG. 1 is a diagram explaining a method 100 of aligning a pair of genome sequences according to one exemplary embodiment of the present disclosure. According to one exemplary embodiment of the present disclosure, the method 100 of aligning a pair of genome sequences refers to a series of processes including comparing a pair of reads (paired-end reads or mate-pair reads) output from a genome sequencer with a reference sequence and determining a mapping (or aligning) position of the corresponding read in the reference sequence. In the following exemplary embodiments, two reads (a 5′ read and a 3′ read) constituting the pair of reads are referred to as a first read and a second read, respectively.

First, when a first read and a second read are input from a genome sequencer (Operation 102), minimum error bounds (mEBs) of a forward sequence and a reversely complementary sequence of each of the two input reads are calculated (Operation 104). In this operation, minimum error bounds of the four sequences, which include the forward sequence of the first read, the reversely complementary sequence of the first read, the forward sequence of the second read, and the reversely complementary sequence of the second read, are calculated respectively. In this case, the minimum error bounds mean minimum values of errors which may take place when each of the sequences is mapped to the reference sequence.

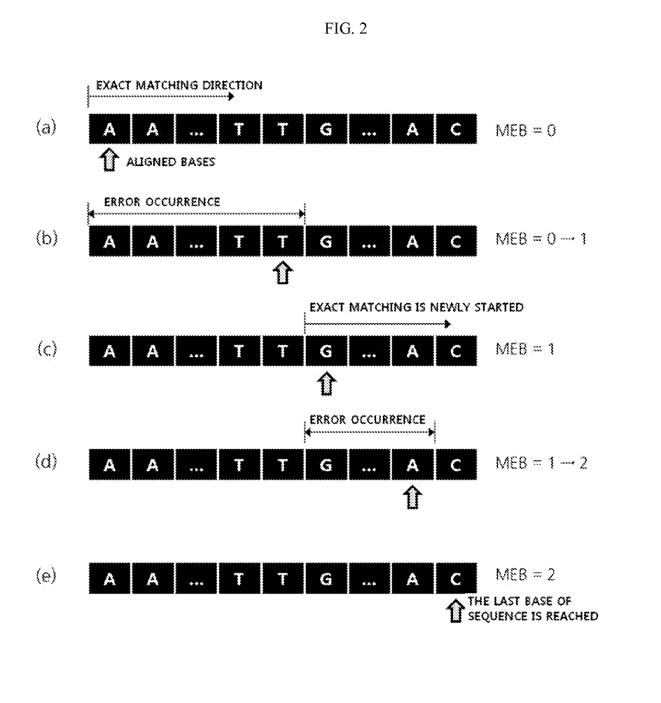

FIG. 2 is a diagram exemplifying a mEB calculation process in Operation 104. First, as shown in FIG. 2A, the first mEB is set to 0, and exact matching is attempted while advancing from a first base (e.g., leftmost base) of a target sequence one by one in a right direction. As shown in FIG. 2B, assume that further exact matching from a certain base (a base represented by the second T in the drawing) of the target sequence is impossible to perform. This means that an error takes place somewhere in a section spanning from a matching start position to a current position of the target sequence. Therefore, an mEB value is increased by one (mEB=1), and new exact matching starts at the next position (shown in FIG. 2C). Next, when it is determined that the exact matching is impossible to perform, it means that another error takes place somewhere in another section spanning from a position at which the exact matching re-starts to a current position. Therefore, a mEB value is increased again by one (mEB=2), and new exact matching starts at the next position (shown in FIG. 2D). Through this process, an mEB value obtained when the end of the sequence (e.g., rightmost sequence) is reached becomes an mEB value of the corresponding sequence.

As such a process is undergone, the mEB value of each of the four sequences including the forward sequence of the first read, the reversely complementary sequence of the first read, the forward sequence of the second read, and the reversely complementary sequence of the second read is calculated.

Next, the four calculated mEB values are compared with a predetermined maximum error allowable value (MaxError) (Operation 106). In this case, when all the four calculated mEB values exceed the MaxError, alignment of the corresponding read is determined to be failed.

However, when some of the mEB values of the sequences are less than or equal to the maximum error allowable value, the sequences in which the calculated mEB values are less than or equal to the maximum error allowable value are selected (Operation 108), and a seed group of the selected sequences is constituted (Operation 110). Thereafter, the reference sequence is divided into a plurality of sections, a mapping histogram is produced by calculating total mapping value of the selected sequences in the respective sections (Operation 112), and the pair of reads are aligned in the reference sequence using the mapping histogram (Operation 114)

Hereinafter, specific processes including Operations 110 to 114 will be described in detail.

Constituting Seed Group from Selected Sequences (Operation 110)

this operation is to produce one or more seeds from the read sequence selected in Operation 108. First, a plurality of fragments are produced in consideration of some or all of the selected sequence. For example, fragments may be produced by dividing an entire or certain section of the sequence into a plurality of pieces or combining the divided pieces. In this case, the produced fragments may be extracted sequentially from the read, but the present disclosure is not limited thereto. For example, it is also possible to constitute fragments as a combination of pieces falling apart in the sequence. Also, the produced fragments do not necessarily have the same length, and thus it is possible to produce fragments having various lengths in one read. In the present disclosure, for example, a method of producing fragments from a read sequence is not particularly limited, and thus various algorithms of extracting fragments from some or all of the read sequence may be used without limitation.

When the fragments are produced from each of the sequences selected through such a process, the produced fragments are then subjected to a filtering process to exclude the fragments which are not matching the reference sequence, thereby constituting a seed group. That is, the exact matching of the produced fragment with the reference sequence is attempted, and the fragments (seeds) in which the number of unmatched bases is less than or equal to a predetermined allowable value are used to constitute a seed group. In this case, the allowable value may be properly determined in consideration of a length of a sequence and lengths of fragments extracted from the sequence. When the sequence has a short length (approximately 50 bp or less), only the fragments exactly matching the reference sequence may be, for example, taken into consideration. In this case, the allowable value may be 0. Also, as the length of the sequence increases, it is possible to prevent mapping accuracy from decreasing to excess by increasing the allowable value by 1 or 2.

Generating Mapping Histogram (Operation 112)

When the seed group is constituted through the above-described process, a mapping histogram of each sequence is then constructed. In the present disclosure, the mapping histogram is an array having a certain size (integer array), and thus a value of the array corresponds to each section when the reference sequence is divided into a plurality of sections having the same size. For example, when the reference sequence is divided into sections having a size of 65536 (=2¹⁶) bp, the section spanning from 0 to 65535 bp in the reference sequence corresponds to a 1^{st} value, h[0], of the mapping histogram (h), and the section spanning from 65536 to 131071 corresponds to a 2^{nd} value, h[1], of the mapping histogram (h). In this way, the divided sections of the reference sequence may correspond to n^{th} values of the mapping histogram.

Also, a total of mapping values of seeds extracted from each read sequence in the corresponding section of the reference sequence is stored in each value (h[i]) of the mapping histogram. In this case, the mapping value may be a total of mapping lengths of the seeds in the corresponding section of the reference sequence. For example, assume that a 53^{rd}-to-67^{th} seed (a seed extracted from 53^{rd} to 67^{th} bases of the read sequence) and a 61^{st}-to-75^{th} seed (a seed extracted from 61^{st} to 75^{th} bases of the read sequence) extracted from a certain read sequence are mapped to a 1^{st} section of the mapping histogram. In this case, a histogram value of the corresponding section is 23 (=75−53+1).

Meanwhile, the mapping value may be a total number of the mapped seeds in the corresponding section of the reference sequence. By the same way of example, since the number of the seeds mapped to the 1^{st} section of the mapping histogram is 2, the histogram value of the corresponding section is 2. Also, according to one exemplary embodiment, the total mapping length and the total mapping number may be stored together as the mapping value in each section.

Aligning a Pair of Reads (Operation 114)

When the mapping histogram is produced in each of the sequences of the first read and the second read through the above-described process, the produced mapping histogram is used to align the pair of reads in the reference sequence.

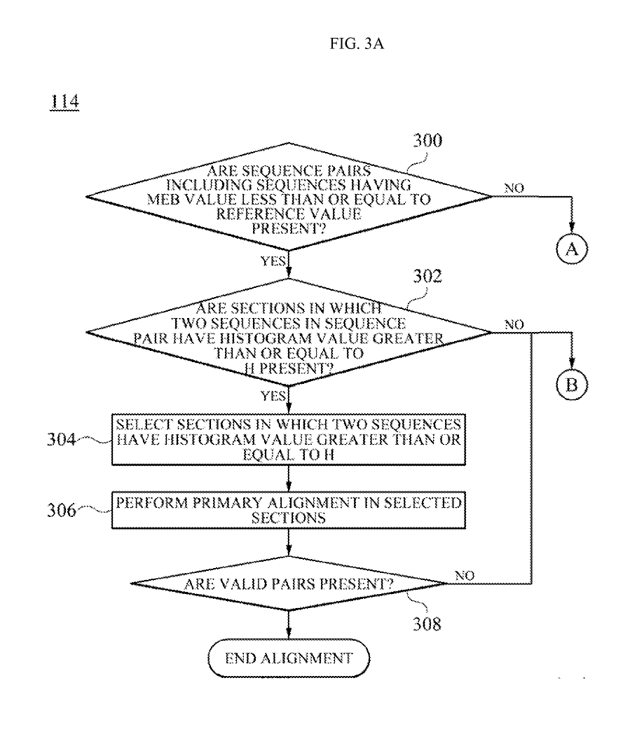

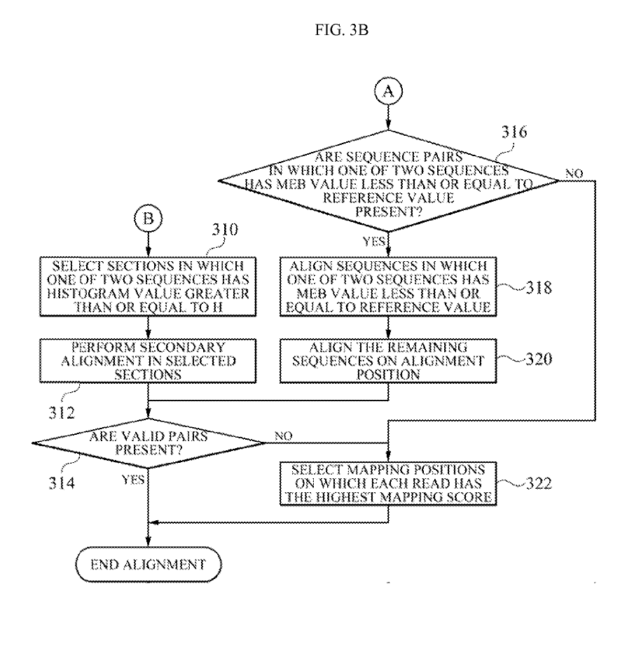

FIGS. 3A and 3B are flowcharts illustrating Operation 114 of aligning a pair of genome sequences in the method 100 of aligning a pair of genome sequences according to one exemplary embodiment of the present disclosure.

First, it is determined whether the read sequences selected in Operation 106 may be used to constitute a sequence pair (Operation 300).

For example, when the pair of reads is paired-end reads, it is determined whether the sequences whose mEB values are less than or equal to a maximum error allowable value which is the reference value may be used to constitute at least one the following pairs:

(The forward sequence of the first read—the reversely complementary sequence of the second read); and

(The reversely complementary sequence of the first read—the forward sequence of the second read).

Also, when the pair of reads is mate-pair reads, it is determined whether the sequences whose mEB values are less than or equal to the maximum error allowable value which is the reference value may be used to constitute at least one the following pairs:

(The forward sequence of the first read—the forward sequence of the second read); and

(The reversely complementary sequence of the first read—the reversely complementary sequence of the second read).

When the results of the judgment in Operation 300 show that at least one of the above-described pairs is able to be constituted, histogram values of the two read sequences constituting a sequence pair are compared to determine whether there are sections of the reference sequence in which both the histogram values of the two sequences are greater than or equal to a histogram cut (Operation 302).

When the results of the determination in Operation 302 show that there are the sections in which both the histogram values of the two sequences are greater than or equal to a histogram cut H, the corresponding section is selected as a mapping target section (Operation 304), and primary alignment on the two read sequences constituting the sequence pair in the selected section is performed (Operations 306 and 308). Specifically, the global alignment in the mapping target section is performed on each of the two read sequences constituting the sequence pair, and an alignment position pair (a valid pair) satisfying a predetermined distance range (an insert size) between the reads in the alignment position pair of the two calculated read sequences based on the results of the global alignment is selected as alignment positions of the first read and the second read (Operation 306). In this case, the valid pair should satisfy the following three requirements.

1) Alignment directions of the two sequences are identical to or correspond to those of the pair of reads input at the very beginning. When the input pair of reads is paired-end reads, each of the sequences should be a reversely complementary relationship. That is, when one sequence is a forward sequence, the other sequence should be a reversely complementary sequence. When the input pair of reads is mate-pair reads, the two sequences should have the same alignment direction.

2) At least one of the two sequences should have an error less than or equal to a maximum error allowable value.

3) A distance between the alignment positions of the two sequences falls within a predetermined mappable range. In this case, the mappable range may be determined as represented by the following Equation 1.

L₁−k*D≦L₂≦L₁+k*D [Equation 1]
wherein L₁ represents a mapping position of a 1^{st} sequence of the two sequences constituting the sequence pair, L₂ represents a mapping position of a 2^{nd} sequence, k represents a weight ranging from 0 to 1.8, and D represents a predetermined difference in distance (an insert size) between the two distances.

In this case, the reason to provide the weight k to the insert size is that the distance between the sequences may be varied by insertion or deletion of some bases due to the nature of the genome sequence, and thus this reflects the variation in distance.

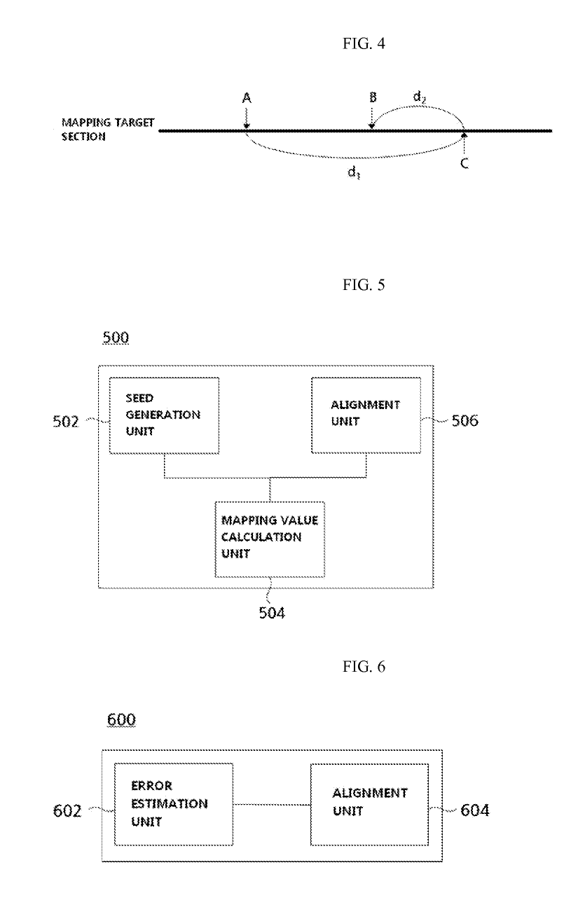

The operation of searching for a valid pair is, for example, described as shown in FIG. 4. In the mapping target section in shown in FIG. 4, it is assumed that the first sequence of the two sequences constituting the sequence pair is mapped to positions A and B, and the second sequence is mapped to a position C. In this case, the following two alignment position pairs are produced:

(A, C); and

(B, C).

It is assumed that an insert size d1 between the positions A and C is set to 1,500 bp, an insert size d2 between the positions B and C is set to 650 bp, and the mappable range obtained in Equation 1 is in a range of −750 bp to 750 bp. In this case, since one of the two alignment position pairs satisfying the above-described mappable range is (B, C), the alignment positions of the first read and the second read become B and C.

As such, the alignment position pair satisfying the above-described mappable range in the selected section is referred to as a valid pair. That is, in the above-described example, the valid pair is (B, C), and when the valid pair is found, alignment of the corresponding paired-end reads is considered to succeed.

On the contrary, when the results of the primary alignment in the section selected in Operation 304 show that there are no valid pairs, or when the results of the judgment in Operation 302 show that there are no sections in which both the histogram values of the two sequences are greater than or equal to H, the sections in which the histogram value of one of the two sequences constituting the sequence pair is greater than or equal to H are selected as the mapping target sections (Operation 310), and secondary alignment is performed in the selected mapping target sections (Operations 312 and 314).

The secondary alignment process will be described in further detail, as follows. First, one of the two sequences is selected, and an alignment position of the selected sequence in the mapping section is calculated. In this case, the sequence selected among the two sequences may be a sequence whose histogram value in the corresponding mapping target section is greater than or equal to H.

Next, it is judged whether the other sequence is mapped within a mappable range set based on the calculated alignment position (local alignment). That is, it is judged whether there are valid pairs satisfying the above-described three requirements within the mappable range. In this case, the mappable range is as described in Equation 1. That is, in this secondary alignment process, the sequences having higher histogram values are used as a kind of anchors to determine whether the remaining sequences around the corresponding sequence are mapped or not.

When the mapping results show that there are the valid pairs, the alignment of the corresponding pair of reads is considered to succeed. On the other hand, when the results obtained in Operations 312 and 314 show that there are no valid pairs, the alignment of the reads is considered to be failed. In this case, each of the first read and the second read is globally aligned in the reference sequence, and alignment positions having the highest alignment score obtained from the global alignment results are output (Operation 322). In this case, the details of the global alignment of each read and the calculation of the alignment score are generally known in the art to which the present disclosure belongs, and thus detailed description of the global alignment and the calculation of the alignment score are omitted for clarity

Meanwhile, when the results of the judgment in Operation 300 show that both the two sequences do not constitute a sequence pair in which mEB values of the sequences are less than or equal to the maximum error allowable value, it is judged whether one of the two sequences has an mEB value less than or equal to the maximum error allowable value (Operation 316). In this case, when the results of the judgment in Operation 316 show that one of the two sequences has an mEB value less than or equal to the maximum error allowable value, an alignment position of the sequence whose nEB value is less than or equal to the maximum error allowable value with respect to the reference sequence is calculated (single end alignment) (Operation 318). Then, it is determined whether there are valid pairs in which the other sequence satisfies the above-described three requirements within the mappable range set based on the calculated alignment position (local alignment) (Operation 320). In this case, the mappable range is as described in Equation 1. That is, in this secondary alignment process, the sequences having mEB values less than or equal to the maximum error allowable value are used as a kind of anchors to determine whether the remaining sequences around the corresponding sequence are mapped or not.

When the mapping results show that there are the valid pairs, the alignment of the corresponding pair of reads is considered to be succeeded. On the other hand, when the results obtained in Operations 318 and 320 show that there are no valid pairs, the alignment of the pair of reads is considered to be failed. In this case, each of the first read and the second read is globally aligned in the reference sequence, and alignment positions having the highest alignment score obtained from the global alignment results are output (Operation 322). Also, the results of the judgment in Operation 316 are as described above even when both the mEB values of the two sequences exceed the maximum error allowable value.

Calculating Histogram Cut

According to the exemplary embodiments, the histogram cut may be calculated, as follows.

First, when the histogram value, that is, the mapping value in each section, is defined as the number of seeds mapped to the corresponding section, the histogram cut should be at least 2. This is because a section to which one seed is mapped has a low probability of mapping reads when considering that a basic mapping unit is a seed. That is, when the histogram value is defined as the number of the seeds mapped to each section, the histogram cut may be properly determined from the integer greater than or equal to 2 in consideration of the lengths of the reads, the lengths of the seeds, etc.

Next, when the histogram value is defined as the length of the seed mapped to the corresponding section, the histogram cut is calculated, as follows. When it is assumed that f represents a size of a fragment, s represents a shift size in a read to produce the fragment, L represents a length of the read, e represents the number of maximum error allowable in the read, and H represents a histogram cut, a length T of a domain which is not affected by the errors in the read may be calculated as represented by the following equation.

T=L−f*e−s

In this case, since L and e are values which may be determined in advance upon practice of the present disclosure, T is determined according to the values f and s. That is, performance of the algorithm varies depending on how the values f and s are changed.

First, the following two requirements are taken into consideration when determining the value H. Among these, the essential requirements are satisfied without exception, and additional requirements are possibly taken into consideration.
Essential requirements: Since a basic mapping unit is a fragment, a histogram cut should have a suitable size to cover at least two overlapping fragments no matter how small the histogram cut may be. When f=15 and s=4 as shown in FIG. 2, since the sum of the minimum lengths of the two overlapping fragments is 19 (15+4), the value H should be at least 19. Also, since the value H is set to cover at least two fragments, the value H is at least greater than or equal to a value of f+s. As will be described later, since the value f should be at least greater than or equal to 15, the value H becomes at least 16 (15+1) on the assumption that the value s is 1 which is the minimum value.
Additional requirements: When a histogram in which the values H and T are set to be H=T and to which sequences having a size greater than or equal to the value T are mapped is found on the assumption of the ideal conditions, all the mapping position of given errors may be found. However, when there are redundancies of the reference sequence as described above, there may be a case of expanding the length of the fragment according to the situations. Therefore, when the value H is determined in consideration of these facts, it is desirable in an aspect of a mapping rate to use a value of T−s which is slightly less than T. When it is assumed that the value H is equal to T, the equation, H=L−f*e−s, is established. Also when the value e is 1 that is the minimum value (the mapping is completed in Operation 104 as described above since a target sequence is exactly matching the reference sequence when the value e is 0), the equation, H=L−f−s, is established. This value becomes the maximum histogram value. When it is assumed that L=75 bp, f=15 bp, and s=1, the maximum H value becomes 59 (75-15-1).

In summary, the value H should be satisfied within the following range.

f+s≦H≦L−(f+s)

Subsequently, the value f selects the higher one of values satisfying the following two requirements. Also, the essential requirements should be necessarily satisfied, and the additional requirements are contemplated if possible.
Essential requirements: The value f should be greater than or equal to 15. This is because the number of the mapping positions in the reference sequence suddenly increases when the fragments have a length of 14 or less.

The following Table 1 lists the average frequencies of occurrence of the fragment in the human genome according to the length of the fragment.

TABLE 1

| Fragment length (bp) | Average frequencies of occurrence |
|---|---|
| 10 | 2,726.1919 |
| 11 | 681.9731 |
| 12 | 170.9185 |
| 13 | 42.7099 |
| 14 | 10.6470 |
| 15 | 2.6617 |
| 16 | 0.6654 |
| 17 | 0.1664 |

As listed in Table 1, it could be seen that the frequency of the fragment is 10 or more when the fragment has a length of 14 or less, but decreases to 3 or less when the fragment has a length of 15. That is, when the fragment is constituted to have a length of 15 or more, redundancies of the fragment are significantly lower compared with a case in which the fragment is constituted to have a length of 14 or less.
Additional requirements: The equation f=L/(e+2) should be satisfied so as to ensure that the length T corresponds to the sum of sizes of two fragments.

For example, when L=100, and e=4, then the value f should be less than or equal to 16.

A method of summarizing the requirements and determining the values f, s and H are summarized, as follows.
The value s is fixed to 4, and the values f and H are then determined.
The highest value is determined to be f in a range of 15≦f≦L/(e+2) (here, it is necessary to satisfy f=15)
H is determined using the following equation.

The higher one of the values calculated by the equation: H=L−f*e−2s or H=f+s.

(wherein H represents a reference value, L represents a length of a read, f represents a length of a fragment, e represents the number of maximum errors in the read, and s represents a shift size between the fragments)

Example 1: when it is assumed that L=75, and e=3,

f=15 to 15, that is, 15,

s=4, and

H=75−3*15−2*4=22.

Example 2: when it is assumed that L=100, and e=4,

f=15 to 16, that is, 16,

s=4, and

H=100−4*16−2*4=36−8=28.

Example 3: when it is assumed that L=75, and e=4,

f=15 to 12, that is, 15, since the value f should be greater than or equal to 15,

s=4, and

H=75−4*15−2*4=15−8=7, but H=19 since f+s=19.

FIG. 5 is a block diagram showing a system 500 of aligning a pair of genome sequences according to one exemplary embodiment of the present disclosure. The system 500 of aligning a pair of genome sequences according to one exemplary embodiment of the present disclosure is a system for aligning a first sequence and a second sequence, which are in the same direction or exhibit a reversely complementary relationship, in the reference sequence, and includes a seed generation unit 502, a mapping value calculation unit 504 and an alignment unit 506.

The seed generation unit 502 generates one or more fragments from each of the first sequence and the second sequence, and constitutes a first seed group and a second seed group from the one or more fragments. The first seed group is configured to include only the fragments mapped to the reference sequence among the one or more fragments extracted from the first sequence, and the second seed group is configured to include only the fragments mapped to the reference sequence among the one or more fragments extracted from the second sequence. Also, the fragments mapped to the reference sequence mean fragments in which the number of unmatched bases is less than or equal to a predetermined number as seen from the results of exact matching with the reference sequence.

The mapping value calculation unit 504 divides the reference sequence into a plurality of sections, and calculates a first mapping value and a second mapping value for each of the sections. In this case, the first mapping value may be a total mapping length in the corresponding section of seeds included in the first seed group, and the second mapping value may be a total mapping length in the corresponding section of seeds included in the second seed group. Also, the first mapping value may be defined as a total number of the mapped seeds included in the first seed group, and the second mapping value may be defined as a total number of the mapped seeds included in the second seed group.

The alignment unit 506 selects a first section in which both the calculated first and second mapping values are greater than or equal to the reference value, and searches for mapping positions of the first sequence and the second sequence in the first section. More particularly, the alignment unit 506 performs global alignment on the first sequence and the second sequence in the first section, and selects an alignment position pair, which satisfies a predetermined distance range between the sequences among alignment position pairs of the calculated first and second sequences.

When there are no sections in which both the first mapping value and the second mapping value are greater than or equal to the reference value, the alignment unit 506 searches for the mapping positions of the first sequence and the second sequence in a second section in which one of the first mapping value and the second mapping value is greater than or equal to the reference value. More particularly, the alignment unit 506 calculates the alignment position of the selected sequence of the first sequence and the second sequence in the second section, and performs global alignment on the other sequence within the mappable range set based on the calculated alignment position.

In this case, the selected sequence may be one of the first sequence and the second sequence which has a relatively higher mapping value in the second section. Meanwhile, the mappable range may be a section corresponding to k*D (here, k represents a weight, and D represents a predetermined distance between the sequences) upstream and downstream of the reference sequence from the mapping position of the selected sequence. In this case, the weight k may be less than or equal to 1.8.

FIG. 6 is a block diagram showing a system 600 of aligning a pair of genome sequences according to one another exemplary embodiment of the present disclosure. The system 600 of aligning a pair of genome sequences according to this exemplary embodiment is a system for aligning a first sequence and a second sequence, which are in the same direction or exhibit a reversely complementary relationship, in the reference sequence, and includes an error estimation unit 602 and an alignment unit 604.

The error estimation unit 602 calculates a minimum error bound of each of the first sequence and the second sequence. More particularly, the error estimation unit 602 performs exact matching of the sequence selected from the first sequence and the second sequence with the reference sequence while from a 1st base of the selected sequence one by one. Here, when it is determined to be impossible to perform the exact matching at a certain position of the selected sequence, the error estimation unit 602 newly performs the exact matching while from a base next to the corresponding position one by one, and sets the number of positions, at which it is judged not to perform the exact matching, as a minimum error bound of the selected sequence when the last base of the selected sequence is reached. In connection with the calculation of the minimum error bound in the error estimation unit 602, the calculation of the minimum error bound is shown in FIG. 2 and described in detail with reference to FIG. 2, and thus repeated description of the calculation of the minimum error bound is omitted for clarity.

The alignment unit 604 calculates an alignment position of one of the first sequence and the second sequence, which has a relatively lower value of the calculated minimum error bounds, with respect to the reference sequence, and performs global alignment on the other sequence within a mappable range set based on the calculated alignment position. In this case, the mappable range may be a section corresponding to k*D (here, k represents a weight, and D represents a predetermined distance between the sequences) forward and backward of the reference sequence from the mapping position of the selected sequence. In this case, the weight k may be less than or equal to 1.8.

Meanwhile, the exemplary embodiments of the present disclosure may include a computer-readable recording medium equipped with programs for executing the methods described herein on a computer. The computer-readable recording medium may include program commands, local data files, local data structures, etc., which may be used alone or in combination. The computer-readable recording medium may be particularly designed or constructed for the purpose of the present disclosure, or may also be known and used by persons of ordinary skill in the computer software-related art. Examples of the computer-readable recording medium may include magnetic media such as hard disks, floppy disks and magnetic tapes, optical recording media such as CD-ROMs and DVDs, magneto-optical media such as floppy disks, and hardware devices, such as ROMs, RAMs and flash memories, which are particularly constructed to store and execute the program commands. Examples of the program commands may include high-level language codes capable of being executed by a computer using an interpreter, as well as machine codes such as those being constructed by compilers.

According to the exemplary embodiments of the present disclosure, an amount of calculations may be significantly reduced, compared with the conventional methods, by selecting sections, which has a probability of making a pair upon aligning the paired-end reads or the mate-pair reads in the reference sequence, in advance, and performing alignment on the paired-end reads or the mate-pair reads in the corresponding section. Also, the present disclosure has an advantage in that it can provide an alignment algorithm capable of aligning a pair of genome sequences even when certain bases are substituted upon alignment of the paired-end reads or mate-pair reads and there are unmatched bases at certain positions by the presence of gaps of inserted or deleted bases.

It will be apparent to those skilled in the art that various modifications can be made to the above-described exemplary embodiments of the present disclosure without departing from the spirit or scope of the disclosure. Thus, it is intended that the present disclosure covers all such modifications provided they come within the scope of the appended claims and their equivalents.

What is claimed is:

1. A system, intended for use in aligning a pair of genome sequences including a first sequence and a second sequence in a reference sequence, the system comprising a computer executing program commands and thereby implementing:
a seed generation unit configured to:
generate one or more fragments from each of the first sequence and the second sequence; and
constitute a first seed group and a second seed group from the one or more fragments;
a mapping value calculation unit configured to:
divide the reference sequence into a plurality of sections; and
for each section of the plurality of sections, calculate a first mapping value of seeds included in the first seed group, and calculate a second mapping value of seeds included in the second seed group; and
an alignment unit configured to:
select a first section, of the plurality of sections, in which the first mapping value and the second mapping value are both at least a predetermined reference value; and
search for mapping positions of the first sequence and of the second sequence in the first section to identify mapped fragments by determining mappings between ones of the one or more fragments and the reference sequence.

2. The system of claim 1, wherein:
the first seed group is constituted of ones of the one or more fragments generated from the first sequence and mapped to the reference sequence; and
the second seed group is constituted of ones of the one or more fragments generated from the second sequence and mapped to the reference sequence.

3. The system of claim 2, wherein each of the ones of the one or more fragments mapped to the reference sequence have a respective number of unmatched bases within a predetermined number, based on a result of an exact matching with the reference sequence.

4. The system of claim 1, wherein the mapping value calculation unit is further configured to calculate:
the first mapping value based on a total mapping length of the seeds included in the first seed group in said each section; and
the second mapping value based on a total mapping length of the seeds included in the second seed group in said each section.

5. The system of claim 1, wherein the mapping value calculation unit is further configured to calculate:
the first mapping value based on a total number of the mapped fragments included in the first seed group in said each section; and
the second mapping value based on a total number of the mapped fragments included in the second seed group in said each section.

6. The system of claim 1, wherein the alignment unit is further configured to:
calculate one or more alignment positions of the first sequence and of the second sequence by performing a global alignment operation with respect to the first section; and
select an alignment position pair among the one or more alignment positions satisfying a predetermined distance range between the calculated one or more alignment positions of the first sequence and the calculated one or more alignment positions of the second sequence.

7. The system of claim 1, wherein, when the first section is not selected, the alignment unit is configured to select a second section, of the plurality of sections, in which only one of the first mapping value and the second mapping value is at least the predetermined reference value.

8. The system of claim 7, wherein the alignment unit is further configured to:
calculate an alignment position in the second section of a selected sequence, selected from one of the first sequence and the second sequence, in the second section; and
perform a global alignment operation with respect to a non-selected sequence, selected from one of the first sequence and the second sequence within a mappable range from the calculated alignment position.

9. The system of claim 8, wherein the alignment unit is further configured to select, as the selected sequence, the one of the first sequence and the second sequence having the highest mapping value in the second section.

10. The system of claim 8, wherein the mappable range is a section corresponding to k*D forward and backward of the reference sequence, from the mapping position of the selected sequence, where:
k represents a weight, and
D represents a predetermined distance between the sequences.

11. The system of claim 10, wherein k is less than or equal to 1.8.

12. A system, intended for use in aligning a pair of genome sequences including a first sequence and a second sequence in a reference sequence, the system comprising:
an error estimation unit configured to calculate a minimum error bound of each of the first sequence and the second sequence; and
an alignment unit configured to:
select, as a selected sequence, one of the first sequence and the second sequence having the lowest value of the calculated minimum error bounds;
calculate an alignment position of the selected sequence with respect to the reference sequence; and
perform a global alignment operation, on a non-selected sequence of the first sequence and the second sequence, within a mappable range set based on the calculated alignment position;
wherein:
the error estimation unit is configured to perform an exact matching operation with respect to the selected sequence with the reference sequence while advancing one by one from a first base of the selected sequence;
the error estimation unit is further configured to newly perform the exact matching operation while advancing one by one from a base next to a certain position of the selected sequence in response to detecting no exact matching at the certain position; and
the error estimation unit is configured to set, as a minimum error bound of the selected sequence, a number of positions at which no exact matching is detected, when the last base of the selected sequence is reached.

13. A method, intended for use in aligning a pair of genome sequences, including a first sequence and a second sequence in a reference sequence, in a system of aligning a pair of genome sequences, the method comprising:
generating, with a seed generation unit, one or more fragments from each of the first sequence and the second sequence;
constituting, with the seed generation unit, a first seed group and a second seed group from the one or more fragments;
dividing, with a mapping value calculation unit, the reference sequence into a plurality of sections;
calculating for each section, with the mapping value calculation unit, a first mapping value of seeds included in the first seed group, and a second mapping value of seeds included in the second seed group;
selecting, with an alignment unit, a first section, of the plurality of sections, in which the first mapping value and the second mapping value are both at least a predetermined reference value; and
searching, with the alignment unit, for mapping positions of the first sequence and the second sequence in the first section to identify mapped fragments by determining mappings between ones of the one or more fragments and the reference sequence.

14. The method of claim 13, wherein:
the first seed group is constituted of ones of the one or more fragments generated from the first sequence and mapped to the reference sequence; and
the second seed group is constituted of ones of the one or more fragments generated from the second sequence and mapped to the reference sequence.

15. The method of claim 14, wherein each of the ones of the one or more fragments mapped to the reference sequence have a respective number of unmatched bases within a predetermined number, based on a result of an exact matching with the reference sequence.

16. The method of claim 13, wherein:
the first mapping value based on a total mapping length of the seeds included in the first seed group in said each section; and
the second mapping value based on a total mapping length of the seeds included in the second seed group in said each section.

17. The method of claim 13, wherein:
the first mapping value based on a total number of the mapped fragments included in the first seed group in said each section; and
the second mapping value based on a total number of the mapped fragments included in the second seed group in said each section.

18. The method of claim 13, wherein the searching for the mapping positions further comprises:
calculating one or more alignment positions of the first sequence and of the second sequence by performing a global alignment operation with respect to the first section; and
selecting an alignment position pair among the one or more alignment positions satisfying a predetermined distance range between the calculated one or more alignment positions of the first sequence and the calculated one or more alignment positions of the second sequence.

19. The method of claim 13, wherein the searching for the mapping positions further comprises, when the first section is not selected, selecting a second section, of the plurality of sections, in which only one of the first mapping value and the second mapping value is at least the predetermined reference value.

20. The method of claim 19, wherein the searching for the mapping positions further comprises:
calculating an alignment position in the second section of a selected sequence, selected from one of the first sequence and the second sequence, in the second section; and performing a global alignment operation with respect to a non-selected sequence, selected from one of the first sequence and the second sequence within a mappable range from the calculated alignment position.
